(19) United States
(12) Patent Application Publication
(10) Pub. No.: US 2010/0016000 A1
(43) Pub. Date: Jan. 21, 2010

(54) Location-Aware, Multimedia-Enabled, Interactive Question Asker

(76) Inventors: William Lee Little, Austin, TX (US); George W. Rodenbusch, Austin, TX (US)

Correspondence Address: LAW OFFICES OF MARK L. BERRIER, 3811 BEE CAVES ROAD, SUITE 204, AUSTIN, TX, 78746, US

(21) Appl. No.: 12/505,779

(22) Filed: Jul. 20, 2009

Related U.S. Application Data
(60) Provisional application No. 61/081,813, filed on Jul. 18, 2008.

(51) Int. Cl. H04W 64/00

(52) U.S. Cl. 455/456.3

(57) ABSTRACT

Systems and methods for location-relevant information communication, including systems and methods for collecting information that may include real-time location determination, location-relevant multimedia information display, user-interactive interfaces for selection of particular location-relevant information, and centralized storage and control of information.

### CROSS-REFERENCE TO RELATED APPLICATIONS

This application claims the benefit of U.S. Provisional Patent Application 61/081,813, filed Jul. 18, 2008, which is incorporated by reference as if set forth herein in its entirety.

### BACKGROUND

### Field of the Invention

The invention relates generally to location-relevant information communication systems and methods and more particularly to systems and methods for collecting information that may include real-time location determination, location-relevant multimedia information display, user-interactive interfaces for selection of particular location-relevant information, and centralized storage and control of information.

### SUMMARY OF THE INVENTION

This disclosure is directed to systems and methods for implementing a location-aware, multimedia-enabled, interactive question asker. This is a way for individuals or organizations to ask questions or make requests in a more specific and appropriate way than is possible with current solutions that are not location aware or multimedia enabled, such as paper forms or conventional internet surveys or quizzes. The system also allows for quick tabulation and display of question results.

Numerous embodiments are possible.

### BRIEF DESCRIPTION OF THE DRAWINGS

Other objects and advantages of the invention may become apparent upon reading the following detailed description and upon reference to the accompanying drawings.

FIG. 1 is a diagram illustrating the architecture of a system in accordance with one embodiment.

FIG. 2 is a diagram illustrating the data model implemented in one embodiment of the present system.

FIG. 3 is a diagram illustrating data flow in one embodiment of the present system.

FIGS. 4A and 4B are a set of diagrams illustrating various ways to ask questions using embodiments of the present system.

FIG. 5 is a diagram illustrating question entry in accordance with one embodiment.

FIG. 6 is a diagram illustrating question transmission in accordance with one embodiment.

FIG. 7 is a diagram illustrating question delivery in accordance with one embodiment.

While the invention is subject to various modifications and alternative forms, specific embodiments thereof are shown by way of example in the drawings and the accompanying detailed description. It should be understood, however, that the drawings and detailed description are not intended to limit the invention to the particular embodiment which is described. This disclosure is instead intended to cover all modifications, equivalents and alternatives falling within the scope of the present invention as defined by the appended claims.

### DETAILED DESCRIPTION OF EXEMPLARY EMBODIMENTS

One or more embodiments of the invention are described below. It should be noted that these and any other embodiments described below are exemplary and are intended to be illustrative of the invention rather than limiting.

As described herein, various embodiments of the invention comprise systems and methods for implementing a location-aware, multimedia-enabled, interactive question asker. This is a way for individuals or organizations to ask questions or make requests in a more specific and appropriate way than is possible with current solutions that are not location aware or multimedia enabled, such as paper forms or conventional internet surveys or quizzes. The system also allows for quick tabulation and display of question results.

It will be helpful to first define some of the terms that are used in the present disclosure.

“Media” means audio, video, still photo, image, illustration, animation, text, interactive content, etc.

“Question” refers to any question or request that can be communicated via Media.

“Server” means a device capable of storing, computing, and transmitting data.

“Client” means a device capable of storing, computing, transmitting, and communicating data.

“Handheld” means a handheld device that is location aware.

“Input device” means a microphone, camera, touch screen, buttons, location device, motion sensor, etc.

“Response” means user input recorded via an input device after a question is displayed

“User” means the person operating the handheld to whom the questions will be presented.

“Location” means an area in space which is determinable to some degree of reliability using a location technology.

“Response meta-data” means data associated with a response such as date, time, response order, location of response, user responding, delay of response, etc.

“Score” means a cumulative record of responses that is computed or ranked based on criterion.

“Question asker” refers to a location-aware, multimedia-enabled, interactive question asker in accordance with the present disclosure.

Embodiments of the invention include a location-aware, multimedia-enabled, interactive question asker. This is a way for individuals or organizations to ask questions or make requests in a more specific and appropriate way than is possible with current solutions that are not location aware or multimedia enabled, such as paper forms or conventional internet surveys or quizzes. The system also allows for quick tabulation and display of question results. This embodiment consists of three parts:
1. a server component that hosts questions and media and also displays responses;
2. a client component that communicates between the server and handheld; and
3. a handheld component which displays media and questions and records responses.

This three-tiered system functions such that the server communicates with the client and the client communicates with the handheld. The system could also function in a two-tiered fashion. In this way the server would communicate directly with the handheld.

Handheld

We will start by examining the handheld. The handheld consists of both hardware and software. The hardware has components that enable it to be aware of its location. Examples of this are GPS outdoors and WIFI indoors. The handheld is also capable of multimedia playback: audio, video, text, images, and/or interactive media. The handheld is also able to store the media or stream it from an external data store. The handheld is capable of recording responses. Example methods for recording are voice via microphone, clicking via buttons, clicking via touch screen, video or still image via camera. The handheld is also able to associate questions, media, and locations with each other. This association can be managed using a relational database or other data store.

Client

The client is responsible for communication between the server and the handheld in the three-tiered system. The client could be a normal PC. The client has methods for communicating to both the handheld and the server. The connection to the server could be accomplished via the internet or some other method. The connection to the handheld could be accomplished via USB, WIFI, FireWire, or some other method. The client should also have a method for inputting which set of questions are to be given to the user and on which handheld. The client should also be able to communicate the user scores either in real time if there is constant connectivity or after completion of questions.

Server

The server may be used to add and edit questions, media, and locations in the system. The server may also be used to compute and report on responses. The server may serve data over the Internet for display on any display platform. For example, information could be delivered via a website to a remote web browser.

Following are various use cases for the handheld, the client, and the server.

Handheld Use Cases

Use Case 1. The handheld presents a question to the user using one of the previously mentioned media formats. The handheld then records the user's response. When recording the response, the handheld should also include the response meta-data. The handheld then either transmits the response immediately to the client or server or stores it for later transmission.

Use Case 2. The above use case, with the precondition that the handheld first determines its location. If its location is within a defined proximity of a location that has been associated with a question, it then presents the question to the user, it then records the response and transmits as in use case 1.

Use Case 3. One of the above use cases, with the addition that questions are asked in a predefined order.

Use Case 4. Use cases 1 or 2, with the addition that the questions asked are dependent on the responses to previous questions asked.

Use Case 5. One of the above use cases, with the addition that the handheld presents media in response to the response to the question. This media can be selected based on the response. For example, the handheld could play back the video clip just recorded or a celebratory animation and/or sound in response to a correct answer.

Use Case 6. One of the above use cases where the handheld additionally communicates the score to the user. For example, the handheld could display the number of questions answered, the number of questions answered correctly, or the ranking based on the value of each question answered correctly and incorrectly.

Use Case 7. Use case 5 or 6, where the handheld additionally offers rewards for better scores. For example, rewards could be in the form of unlocking a feature or signaling that a prize will be given to the user later.

Use Case 8. Use case 6 or 7, where the handhelds communicate scores to either the client or server via a two way communication protocol such as wifi and display scores of other users.

Use Case 9. One of the above cases with the addition that the order of questions asked is influenced by the locations, responses, and/or scores of other users.

Use Case 10. The handheld can also be used to collect locations where questions should be asked and to record media associated with that question.

Client Use Cases

Use Case 1. Handheld connects with client and client transmits questions and media to handheld either at time of playback or before. These questions are then used as explained in handheld section.

Use Case 2. The above use case with the addition that specific questions are selected on the client via an input device. The selection is then transmitted to the handheld.

Use Case 3. One of the above use cases with the addition of display of responses, locations, and/or scores of users.

Use Case 4. Display of server features

Server Use Cases

Use Case 1. A person adds questions, media, and locations and associates them with each other. These are then passed to the client or directly to the handheld via the internet or another type of data connection.

Use Case 2. Use case 1 with the added ability to give criterion for scoring the responses.

Use Case 3. Server computes and displays statistics on questions and answers based on time, date, location, order, delay, and any other recoded data.

Use Case 4. Server computes and displays statistics on correlations between multiple results from use case 3.

Use Case 5. Playback of responses.

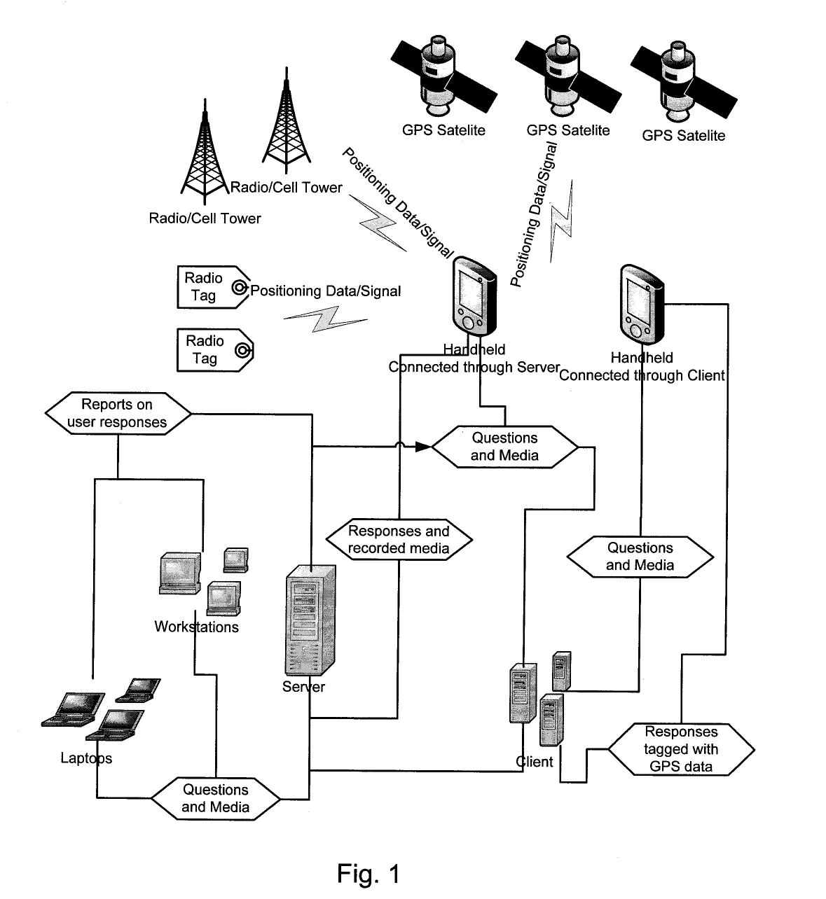

Architecture Diagram. Referring to FIG. 1, a diagram illustrating the architecture of a system in accordance with one embodiment is shown.

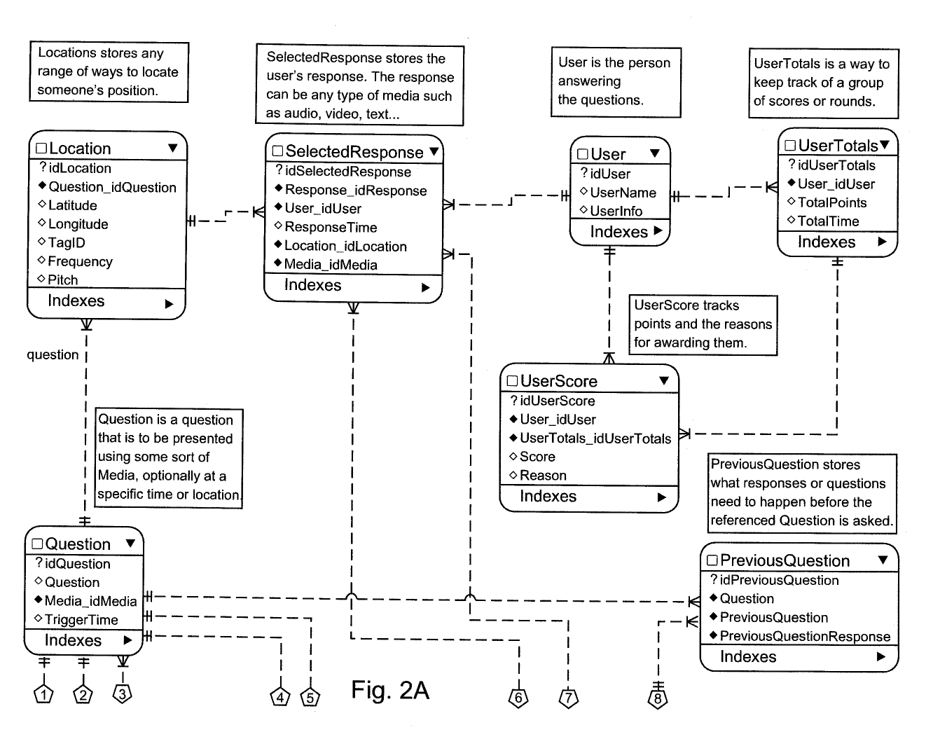

Data Model. Referring to FIG. 2, a diagram illustrating the data model implemented in one embodiment of the present system is shown.

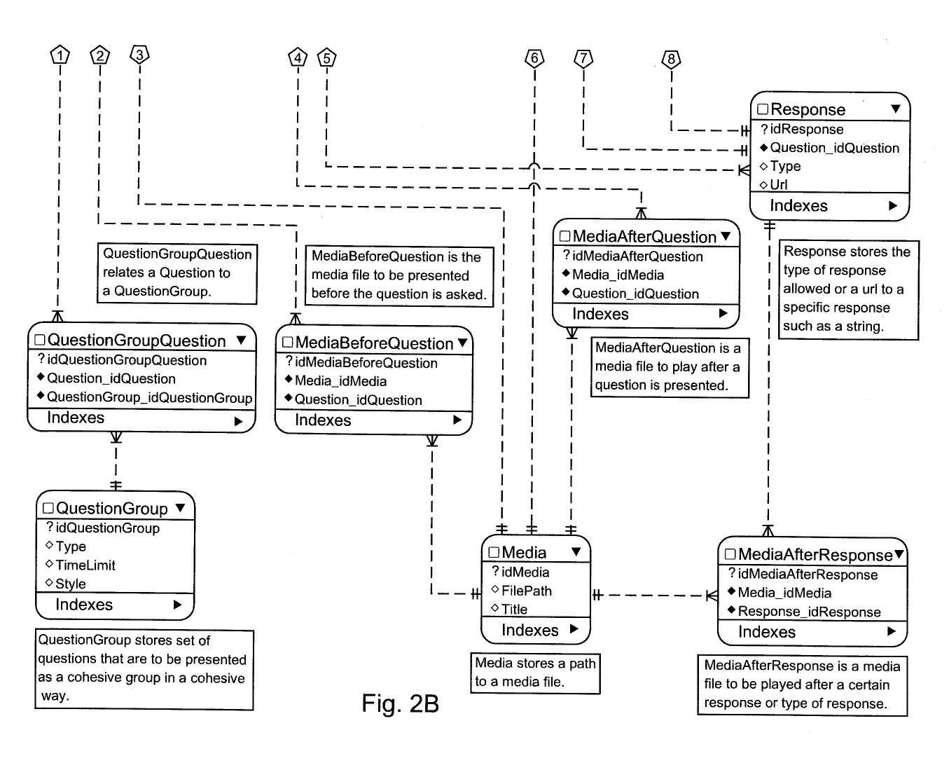

Data Flow Diagram. Referring to FIG. 3, a diagram illustrating the data flow in one embodiment of the present system is shown.

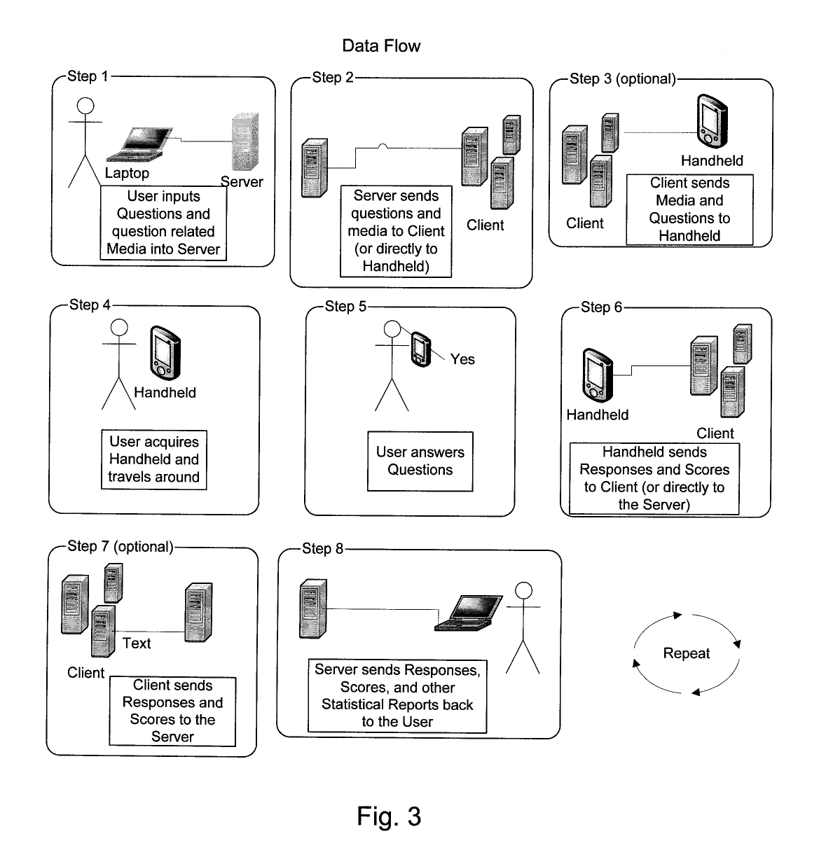

Ways to Ask Questions. Referring to FIGS. 4A and 48, a set of diagrams illustrating various ways to ask questions using embodiments of the present system are shown.

Example Implementation

The following is an example implementation of the question asker. In this example we will consider a sculpture garden. This sculpture garden will be understood to have sculptures both outdoors in a garden area and indoors in a museum area. The question asker will be used to relay important contextual information to users, ask questions about the user's experience, record the users responses deliver awards for certain responses, and report back to the sculpture garden's manager about usage.

Question Entry

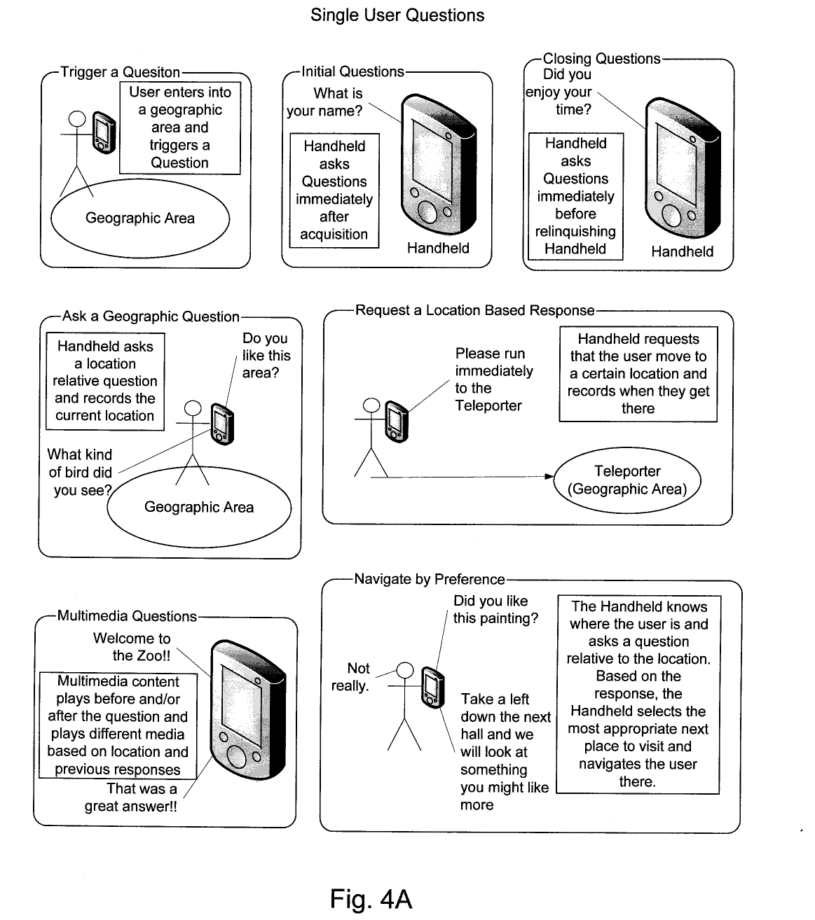

The manager of the sculpture garden starts the process by logging into the server using a workstation in her office. The manager accesses the server over the internet via a website. The website looks something like the site depicted in FIG. 5.

At the home page the manager logs in using a username and password. She then goes to the location page. At the location page she enters latitude and longitude coordinates for each of the sculptures in the garden. Then she enters an rfid number for each of the sculptures and historical artifacts in the museum. She then navigates to the media page. On the media page, she uploads video files about each sculpture. She then uploads a video file to play when a user answers correctly and one for when the answer incorrectly. She then navigates to the question page. On the question page she enters in some text questions and some text available responses. She also enters in one question that has a video type response so that the user can respond by recording a video. She then links these questions to media she uploaded on the media page. She also links the questions to locations where they should trigger. For one question she links to a location that the user should be navigated to after the question is asked. On the question page, the manager also assigns certain scores to each question.

The manager then goes to the questions page. On the questions page, she organizes the questions. The questions about the sculptures in the garden she relates in a group she calls out door questions. She marks the out door questions group as a group that gets scored on the screen. She creates another group of questions for the sculptures in the museum. That group she marks as not scored. She also relates the museum questions in a serial order so that they play one after another as the user goes room to room.

Question Transmission

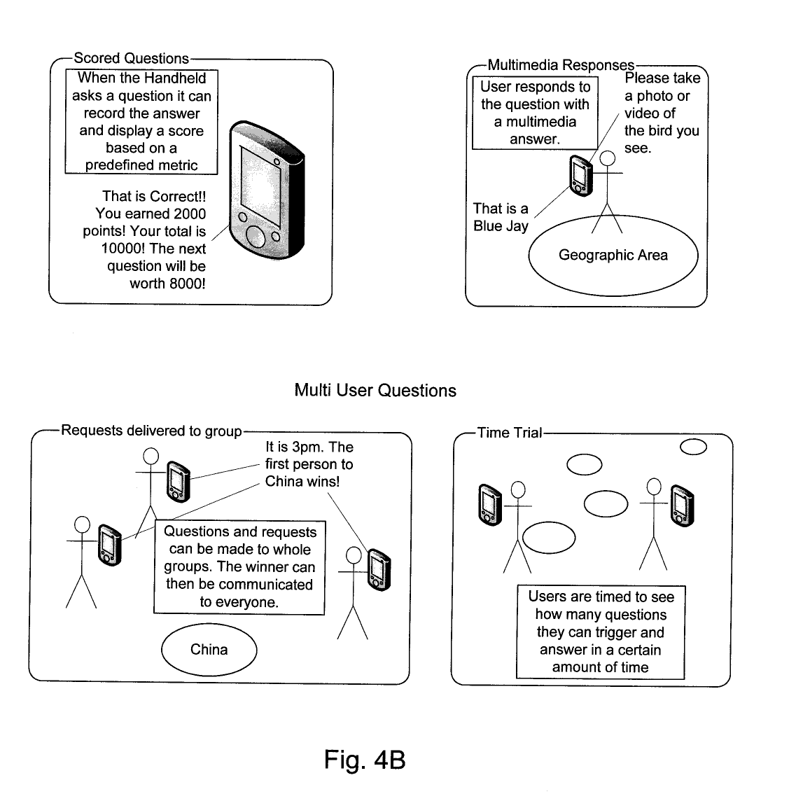

To set up the devices, the manager attaches all of the handhelds to the client machine via a USB cable. She then launches the client software which is similar to the design shown in FIG. 6.

She logs in using her username and password. She then goes to the download screen. She clicks a button on the download screen downloads all of the files from the server via FTP to the client and then to the handhelds. She then navigates to the question selection screen. She selects a set of questions and a set of handhelds to display the questions and clicks a button to start the handheld software. She then gives the handheld to the user for usage. When the user returns the handheld after answering some questions, she reconnects the handheld to the client via a USB cable. The client software then navigates to the upload screen and pulls the response data from the handheld and uploads it to the server over an xml web service.

Question Delivery

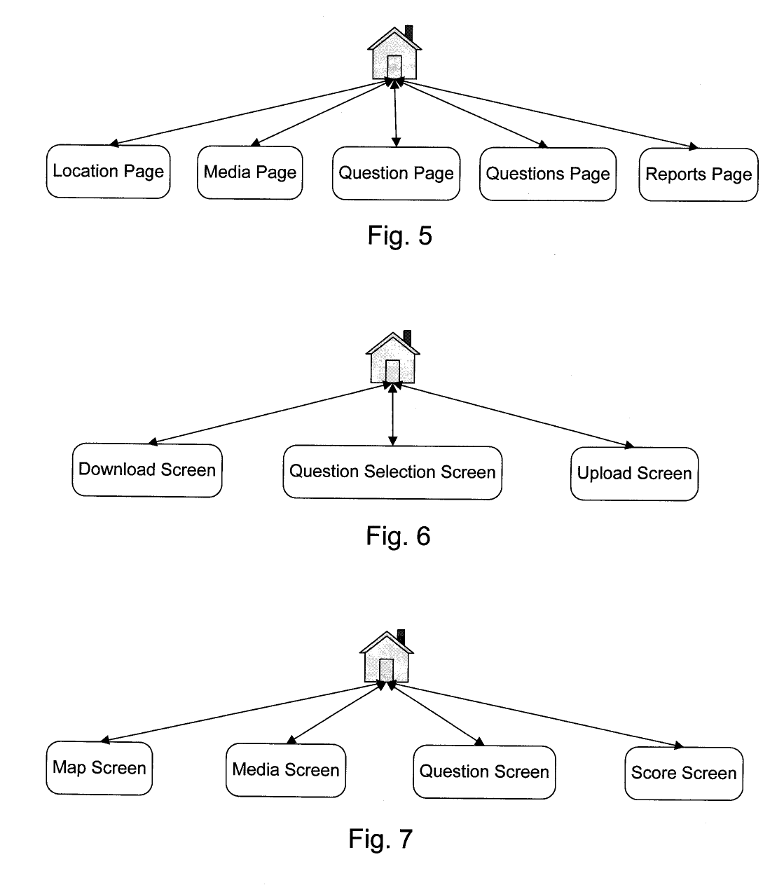

When the manager hands over the handheld to the user, the user travels around the sculpture garden. The user is presented with an application similar to the design shown in FIG. 7.

While the user travels around the outdoor garden, the handheld application continuously checks the proximity to the coordinates that the manager entered on the location page of the server. If the user travels within a predefined radius from those coordinates, the question associated with that location is presented.

First a media file is played and then text containing a question and buttons for available responses are shown. The user selects a response. When the user selects a correct response, the media associated with the correct response is played. When the user selects an incorrect response, the media associated with the incorrect response is played. The handheld records that response in an XML document.

The user then navigates to the question screen and views a list of available questions and which they have already responded to. The user selects a question that did not have an associated location. That question asks the user to travel to their favorite part of the garden and click the “now”. The user travels to the pond and clicks “now” button. The handheld records that location to an XML document.

Once the user has visited as many questions as they want in the garden area, they travel inside to the museum area. When they enter the museum area, the RFID reader in the handheld detects an RFID tag and reads the ID associated with that tag. The tag relates to a location which relates to a question and the question is presented. The question asks what the user thought of the garden. The user responds but no correct or incorrect media is played because this is a non-scored group of questions.

The user then navigates to the score screen. The handheld application makes a web service call over wireless internet to the client to get the current scores of everyone in the sculpture garden. The scores for everyone in the garden are then presented to the user. As the user travels around the museum, the handheld navigates the user to the next location and only presents questions in the predefined order. Finally, the user returns the handheld to the manager and thanks them for the informative and entertaining tool.

Reporting

The manager then logs into the server website again. She navigates to the reports page. On the reports page, the server website presents the responses to the questions, the scores of all the users, the paths taken by all of the users the average path taken by users, the amounts of time spent in certain areas, and the locations where users specified was their favorite.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A location-aware, multimedia-enabled, interactive question asker, comprising:
a server
a client; and
a handheld device;
wherein the client is configured to receive questions and media content from the server and to communicate the questions and media content to the handheld device;
wherein the handheld device is configured to present the questions and media content to a user and to enable the user to input responses to the questions;
wherein the client is further configured to receive responses from the handheld device and to communicate the responses to the server; and
wherein the server is configured to store responses, perform analyses of the responses, and provide the responses and analyses to an operator.
